(19) United States
(12) Patent Application Publication
(10) Pub. No.: US 2007/0115467 A1
(43) Pub. Date: May 24, 2007

(54) Apparatus and method for ensuring rotation of a container during inspection

(75) Inventors: John W. Juvinall, Ottawa Lake, MI (US); Brian A. Langenderfer, Sylvania, OH (US)

Correspondence Address: OWENS-ILLINOIS, INC., ONE MICHAEL OWENS WAY, THREE O-I PLAZA, PERRYSBURG, OH, 43551-2999, US

(73) Assignee: Owens-Brockway Glass Container

(21) Appl. No.: 11/287,331

(22) Filed: Nov. 23, 2005

(51) Int. Cl. G01N 21/00

(52) U.S. Cl. 356/239.4; 356/240.1

(57) ABSTRACT

Apparatus for inspecting a container includes an optical inspection device having at least one light source for directing light energy onto the container as the container is rotated around an axis, and at least one light sensor for receiving light energy from the light source following interaction with the container. An image processor is coupled to the sensor for detecting rotation of the container as a function of fluctuations in the output from the sensor. Rotation of the container will cause some fluctuation in the output of the sensor due to interaction of the light energy with the container. The absence of any detected fluctuations in the sensor output is interpreted as an indication that the container is not rotating, either due to malformation of the container, malfunction of the mechanism for rotating the container, or some other reason.

The present disclosure relates to inspection of containers such as glass containers, and more particularly to an apparatus and method for ensuring that the container is being rotated during an inspection operation.

### BACKGROUND AND SUMMARY OF THE DISCLOSURE

In the manufacture of containers such as glass bottles and jars, various types of anomalies can occur in the sidewalls, heels, bottoms, shoulders, necks and/or finishes of the containers. These anomalies, termed “commercial variations” in the art, can affect the commercial acceptability of the containers. Commercial variations can include variations such as stones or cracks in the walls of the container, or can include dimensional variations in the containers that can affect further processability of the containers.

It has been proposed to employ various electrical, electro-optical and electro-mechanical techniques to inspect containers for commercial variations. Many of these inspection techniques require that the container be held in stationary position and rotated around an axis during the inspection operation. It is important when employing such inspection techniques that the container actually be rotating during the inspection process. A container that is so malformed as to be non-rotatable could be mistaken by automated inspection equipment for a container that is rotating but in which no commercial variations are detected. In the same way, a malfunction at the mechanism for rotating the container such that the container is not rotated during the inspection operation could be mistaken by automated inspection equipment for a container that is rotating but in which no commercial variations are detected. It also has been proposed to provide a reflector on a back-up roller engaged by the container and optics for monitoring the reflector. If the container itself is rotating, the container will rotate the back-up roller. Rotation of the back-up roller and its reflector is sensed by the optics to confirm that the container is being rotated during inspection. This technique requires addition of components (the reflector and optics) to the inspection station, and can be difficult to implement in an otherwise crowded inspection apparatus.

The present disclosure embodies a number of aspects that can be implemented separately from or in combination with each other.

Apparatus for inspecting a container, in accordance with a first aspect of the present disclosure, includes an optical inspection device having at least one light source for directing light energy onto the container as the container is rotated around an axis, and at least one light sensor for receiving light energy from the light source following interaction with the container. An image processor is coupled to the sensor for detecting rotation of the container as a function of fluctuations in the output from the sensor. In other words, it is expected that rotation of the container will cause some fluctuation in the output of the sensor due to interaction of the light energy with the container. The absence of any detected fluctuations in the sensor output is interpreted as an indication that the container is not rotating, either due to malformation of the container, malfunction of the mechanism for rotating the container, or some other reason. A detected absence of rotation at the container preferably results in rejection of the container inasmuch as it cannot be confirmed that the container has been inspected.

In an apparatus for inspecting a container for commercial variations while the container is rotated around an axis, in accordance with another aspect of the present disclosure, facility for ensuring that the container is rotated during inspection includes at least one light source for directing light energy onto the container and at least one light sensor for receiving light energy from the light source following interaction with the container. An image processor detects rotation of the container as a finction of fluctuations in the light energy received at the sensor. The image processor preferably gathers and stores image data from the sensor as a function of apparent rotation of the container, such as at increments of container rotation or at equal time increments while the container apparently is rotated at constant velocity. The image processor then analyzes the stored image data for fluctuations as a function of apparent container rotation. This preferably is accomplished employing a sliding data window to identify fluctuations in the stored image data. The length of the image data window, the length ofthe sliding data window for analyzing the image data, and the magnitude of the fluctuations needed to indicate rotation of the container preferably are adjustable. Other image data analysis techniques can be used to detect fluctuations in the image data that confirm that the container is rotating during inspection.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a schematic diagram of a container inspection apparatus in accordance with one exemplary embodiment of the disclosure;

FIG. 2 is a schematic diagram of an apparatus for inspecting a container in accordance with another exemplary embodiment of the disclosure;

FIG. 3 is a schematic diagram of an apparatus for inspecting a container in accordance with a third exemplary embodiment of the disclosure; and

FIG. 4 is a graphic illustration of container inspection image analysis in the exemplary embodiment of FIG. 1.

### DETAILED DESCRIPTION OF PREFERRED EMBODIMENTS

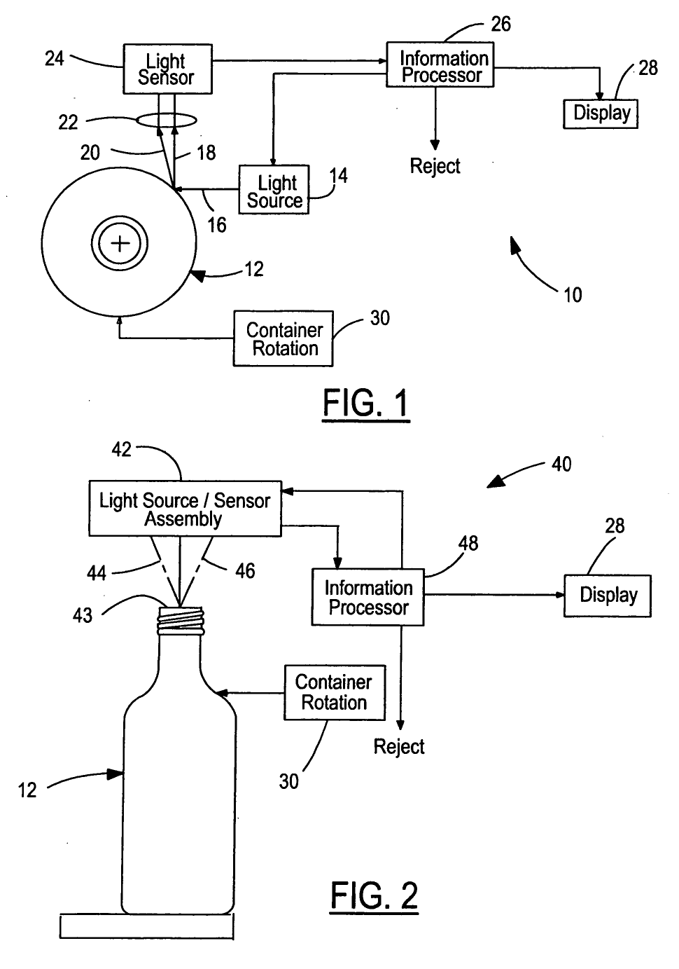

FIG. 1 illustrates an apparatus 10 for inspecting a container 12 in accordance with one exemplary embodiment of the disclosure. The apparatus includes a light source 14 for directing a light beam 16 onto the outer surface of the sidewall of container 12 at an angle such that a portion 18 of the light energy is reflected from the outer surface of the container sidewall, and a portion 20 is refracted into the container sidewall, reflected from the inner sidewall surface and then re-emerges from the outer sidewall surface. A lens 22 is disposed between a light sensor 24 and the container sidewall for directing onto the sensor light energy reflected from the inner and outer sidewall surfaces. An information processor 26 is responsive to signals from light sensor 24. Information processor 26 preferably is connected to a suitable display 28 for displaying inspection data, and to a suitable mechanism for rejecting containers 12 for which commercial variations detected at information processor 26 are of undesirable magnitude. To the extent thus far described, apparatus 10 is similar to that disclosed in U.S. Pat. No. 5,291,271, the disclosure of which is incorporated herein by reference.

A container rotation mechanism 30 rotates container 12 around an axis of rotation as the container is illuminated by light source 14. Container rotation mechanism 30 may comprise a suitable device, such as a drive roller coupled to a suitable drive motor, for holding container 12 against back-up rollers or the like while rotating the container around an axis of rotation. Such axis of rotation preferably is coincident with the axis of the container. By way of example only, systems for bringing sequential containers 12 into position for inspection, rotating the containers in turn during an inspection operation, removing the containers following inspection and rejecting containers that do not pass inspection are illustrated in U.S. Pat. Nos. 4,378,493 and 6,581,751. Information processor 26 preferably scans and stores image data from light sensor 24 at increments of (apparent) container rotation, which can be equal angular increments of container rotation as detected by a suitable encoder coupled to a drive roller or motor, or equal time increments while the container is rotated at constant angularvelocity. A combination ofthese techniques can be employed during acceleration and deceleration of (apparent) container rotation to increase container inspection speed.

FIG. 4 illustrates image data 18a, 20a at light sensor 24 scanned and stored at information processor 26 for reflected light beams 18, 20 (FIG. 1) over an image width 32. Image width 32 preferably is in units of apparent container rotation, such as for example over a complete apparent revolution of the container. Image data 18a is indicative of the position of the outer surface of the container sidewall relative to light sensor 24, and image data 20a is indicative of the apparent position of the inside sidewall surface. (The relationship between image data 20a and the actual position of the inside container sidewall surface is discussed in above-noted U.S. Pat. No. 5,291,271.) The separation 34 between data lines 18a, 20a is indicative of container sidewall thickness. Data 18a and 34 are analyzed to determine outer surface contour and sidewall thickness.

To confirm that the container is actually rotating during inspection in this exemplary embodiment, data 18a and 34 preferably are analyzed for fluctuations that result from container rotation. In the illustrated embodiment, this data analysis preferably is carried out using a sliding data window technique, for which three window positions 36a, 36b, 36n (in units of apparent container rotation) are indicated in FIG. 4. At each sliding window position, outside surface position data 18a and thickness data 34 are analyzed to identify fluctuations in the image data within the sliding window. It can be expected that, if the container is rotating during the inspection operation, there will be some fluctuation in image data caused by minor imperfections in the container geometry. Information processor 26 identifies these fluctuations to confirm that the container was actually rotating during the inspection operation. If the image data 18a, 20a, 34 are such that there are no fluctuations in the image data, information processor 26 determines that the container is not rotating during inspection, and preferably signals the container handling system to reject the container. A persistent container rotation failure may indicate malfunction of the container transport and/or rotation mechanism and call for repairs.

It will be noted in FIG. 4 that, although fluctuations in image data 18a and 34 (and image data 20a) are illustrated, these fluctuations may not be of sufficient magnitude to indicate an unacceptable commercial variation. Image data fluctuations that indicate an unacceptable commercial variation typically would be of greater magnitude (preferably adjustable) than image data fluctuations that indicate container rotation.

FIG. 2 illustrates a container inspection apparatus 40 that includes a light source/sensor assembly 42 positioned above the sealing surface 43 of container 12 to direct at least one beam 44 of light energy onto the container sealing surface and receive at least one reflected beam 46 from the sealing surface. There preferably are multiple light sources and sensors in assembly 42 in associated pairs to direct light energy onto and receive light energy reflected from angularly spaced positions around the sealing surface. Information processor 48 scans assembly 42, preferably at fixed time or spatial increments of(apparent) container rotation as previously described, to receive signals indicative of the position or level ofthe sealing surface relative to assembly 42. To the extent thus far described, apparatus 40 is similar to that disclosed in U.S. Pat. No. 6,903,814, the disclosure of which is incorporated herein by reference. Information processor 48 preferably also analyzes fluctuations in the image data from assembly 42, following interaction of the light energy with container 12, to confirm that the container is rotating during the inspection operation. This preferably is accomplished by analyzing reflected beam(s) 46 for fluctuations indicative of container rotation, such as by using a sliding window technique of the type discussed above.

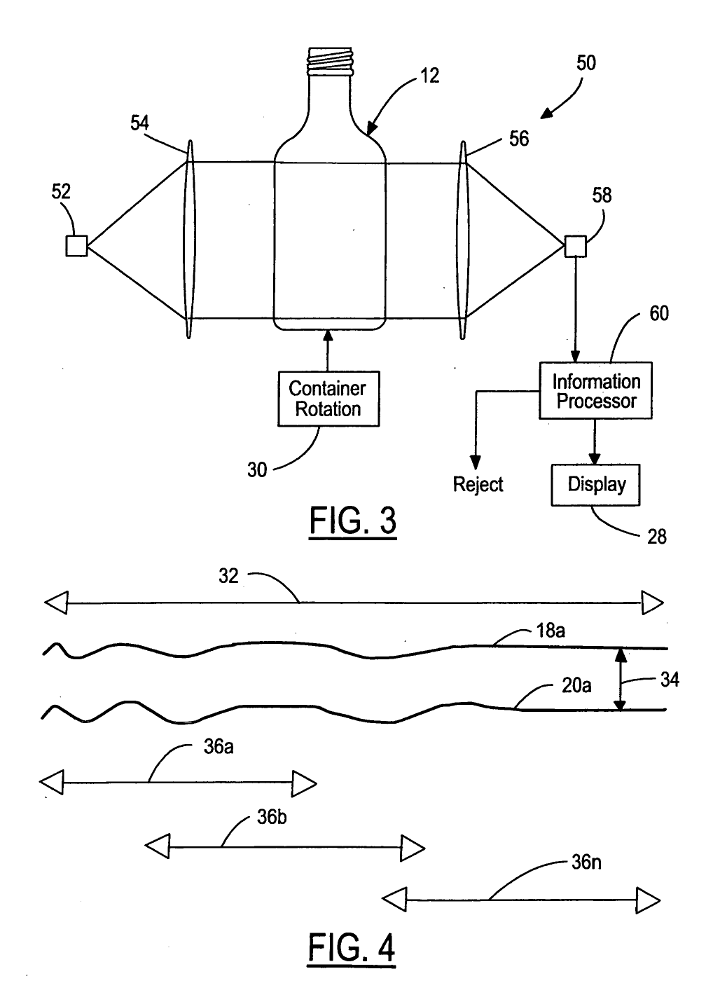

FIG. 3 illustrates a third exemplary apparatus 50 in accordance with the present disclosure. A light source 52 directs light energy onto the sidewall of a container 12 under inspection, such as through a lens 54. Following interaction of the light energy with the container sidewall, such as by transmission through the sidewall or reflection from the sidewall, the light energy is directed onto a sensor 58, such as by a lens 56. An information processor 60 is responsive to the light energy at sensor 58, from light source 52 following interaction with container 12, both to detect commercial variations in container 12 and to confirm that the container is being rotated during the inspection operation. FIG. 3 is intended to be illustrative of numerous different types of container inspection techniques, of which the following disclosures are exemplary and incorporated herein by reference: U.S. Pat. Nos. 4,442,934, 4,579,227, 4,584,469, 4,608,709, 4,644,151, 4,701,612, 4,945,228, 4,958,223, 5,200,801, 5,214,713, 5,233,186, 5,243,400, 5,442,446, 5,466,927, 5,610,391, 5,637,864, 5,896,195, 5,969,810, 6,025,909, 6,067,155, 6,104,482, 6,175,107, 6,256,095.

There thus have been disclosed a method and apparatus for inspecting containers, such as glass containers, which ensure that the container is being rotated during the inspection operation. The basic principle of the present disclosure is that containers are not perfect, so that analysis of the inspection data should reveal fluctuations that may be within acceptable limits for commercial variations, but confirm that the container is being rotated during the inspection operation. A particular advantage of the exemplary embodiments of the present disclosure is that image data from performing other container inspection operations—e.g., container sidewall thickness and roundness in FIG. 1, container sealing surface inspection in FIG. 2 and container sidewall inspection in FIG. 3—are employed for implementing the present disclosure by analyzing the data obtained during the inspection operation for fluctuations that confirm rotation of the container. As a less preferred alternative, a light source and sensor could be provided solely for confirming container rotation. The exemplary embodiments employ inspection data that are scanned into the information processor during (apparent) container rotation and then analyzed both for inspection purposes and to confirm container rotation. However, the inspection data could be monitored in real time during scanning to confirm container rotation. The disclosure has been presented in conjunction with several exemplary embodiments, and other modifications and variations have been described. Additional modifications and variations readily will suggest themselves to persons of ordinary skill in the art in view of the foregoing discussion. The disclosure is intended to embrace all such modifications and variations as fall within the spirit and broad scope of the appended claims.

1. Apparatus for inspecting a container, which includes:
means for rotating a container around an axis,
an optical inspection device that includes at least one light source for directing light energy onto the container in said rotating means, and at least one light sensor for receiving light energy from said light source following interaction with the container, and
an image processor coupled to said sensor for detecting fluctuations in an output from said sensor and determining from said fluctuations that the container is rotating during inspection.

2. The apparatus set forth in claim 1 wherein said image processor is responsive to said sensor for detecting commercial variations in the container, wherein said apparatus includes a reject mechanism responsive to said image processor for rejecting containers having unacceptable commercial variations, and wherein said image processor is coupled to said reject mechanism for rejecting containers for which an absence of rotation is detected by said image processor.

3. The apparatus set forth in claim 1 wherein said image processor gathers and stores image data from said sensor as a function of apparent rotation of the container, and analyzes stored image data for output fluctuations from said sensor indicative of actual rotation of the container.

4. The apparatus set forth in claim 3 wherein said image processor analyzes image data employing a sliding data window to identify fluctuations in said image data within said window.

5. The apparatus set forth in claim 4 wherein length of said window in units of apparent container rotation and magnitude of fluctuations in said image data for detecting actual rotation of the container are adjustable at said image processor.

6. The apparatus set forth in claim 1 wherein said optical inspection device provides signals indicative of roundness and thickness of a sidewall of a container in said rotating means, and wherein said image processor is responsive to both of said signals to detect an absence of rotation at said container.

7. In an apparatus for inspecting a container for commercial variations while the container is rotated around an axis, means for ensuring that the container is actually rotated during inspection, which include:
at least one light source for directing light energy onto the container,
at least one light sensor for receiving light energy from said source following interaction of said light energy with the container, and
an image processor for detecting actual rotation of the container as a function of fluctuations in said light energy received at said sensor.

8. The apparatus set forth in claim 7 wherein said image processor gathers and stores image data from said sensor as a function of apparent rotation of the container, and analyzes stored image data for output fluctuations from said sensor indicative of actual rotation of the container.

9. The apparatus set forth in claim 8 wherein said image processor analyzes image data employing a sliding data window to identify fluctuations in said image data within said window.

10. The apparatus set forth in claim 9 wherein length of said window in units of apparent container rotation and magnitude of fluctuations in said image data for detecting actual rotation of the container are adjustable at said image processor.

11. The apparatus set forth in claim 7 wherein said image processor also is responsive to light energy at said sensor for detecting commercial variations in the container.

12. A method of detecting rotation of a container during optical inspection for commercial variations, in which light energy is analyzed after interaction with the container to identify fluctuations in the light energy indicative of actual rotation of the container during inspection.
